(19) United States
(12) Patent Application Publication
(10) Pub. No.: US 2018/0047041 A1
(43) Pub. Date: Feb. 15, 2018

(54) GAME SYSTEM FOR MOTIVATING PLAYERS TO EAT HEALTHY

(71) Applicant: Humana Inc., Louisville, KY (US)

(72) Inventors: Jeffrey Marsh, Louisville, KY (US); Stuart Slutzky, Deerfield, IL (US)

(21) Appl. No.: 15/233,722

(22) Filed: Aug. 10, 2016

(51) Int. Cl. G06Q 30/02; G07F 17/32; G06F 17/30

(52) U.S. Cl. CPC G06Q 30/0209; G06F 17/30312; G07F 17/3255; G07F 17/3216; G07F 17/3211

(57) ABSTRACT

A game system for motivating people to eat healthy. A game player picks objects located on a game board that hides healthy and unhealthy foods. The number of healthy foods uncovered by the player determines the amount of discounts the player will receive on purchases of healthy food at a participating grocery store.

### BACKGROUND OF THE INVENTIVE FIELD

The present invention is directed to a game system for motivating people to eat healthy. A game player picks objects located on a game board that hides healthy and unhealthy foods (e.g., apples and fast food). The number of healthy foods uncovered by the player determines the amount of discounts the player will receive on purchases of healthy food at a participating grocery store.

Health insurance companies often provide wellness and rewards programs to incentivize their members to maintain healthy lifestyles. These programs benefit members and insurers by lowering health care costs for insured members. These health rewards programs are designed to reward members for making healthier choices (e.g., exercise and diet) and achieving personal health goals. These programs reward members by providing them points that can be used to redeem gifts or rewards such as gift cards from retailers, health products, or travel perks such as flights or hotel stays.

### SUMMARY OF THE GENERAL INVENTIVE CONCEPT

The present invention relates to a game system to incentivize people to eat better through savings on healthier foods (e.g., fruits, vegetables, low-fat dairy). The game system may be implemented by a health insurance company in partnership with a retail grocery store. Health insurance members may be provided with the game board at predetermined set intervals (e.g., once a month) to obtain savings discounts on healthy food for that particular game interval. In one embodiment, the present invention is comprised of: a mobile processing application; an electronic game board generated by the mobile processing application, the electronic game board comprising a plurality of game objects, wherein some of the plurality of game objects are associated with a healthy food item and wherein some of the plurality of game objects are associated with an unhealthy food item; a database for storing identification information for a player and current health food discount data for the player; wherein said mobile processing application is programmed with one or more software routines executing on the mobile processing application to: 1) generate the electronic game board; 2) allow the player to select a predetermined number of game objects; 3) display either a healthy food item or an unhealthy food item each time the player selects a game object; 4) determine the player's current health food discount based on the number of game objects selected by the player associated with a healthy food item; 5) store the current health food discount data for the player after the player makes all of the predetermined number of selections.

The foregoing and other features and advantages of the present invention will be apparent from the following more detailed description of the particular embodiments, as illustrated in the accompanying drawings.

### BRIEF DESCRIPTION OF THE DRAWINGS

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates one embodiment of the home screen for a mobile application game for the present invention;

FIG. 2 illustrates one embodiment of an electronic game board of the present invention;

FIG. 3 illustrates the electronic game board of FIG. 2 showing three of the game objects selected by the player uncovering hidden food items;

FIG. 4 illustrates one embodiment of the rules screen of the present invention;

FIG. 5 illustrates one embodiment of the user card for use at retail stores.

### DETAILED DESCRIPTION OF EXEMPLARY EMBODIMENT(S)

The present invention relates to an interactive game system, offered both online and through a mobile application, in which a plurality of game objects or tiles are visible to a game player via an electronic game board. In one embodiment, there are twelve (12) game tiles the player may choose from. In this embodiment, hidden behind these twelve tiles are six healthy items (e.g., apples) and six non-healthy (e.g., fast food burgers with fries). The goal is to find as many healthy items the player can by clicking on a tile to see what is behind it. After the player has clicked on six tiles, the player will see their earned savings discount. This discount will apply to healthy foods purchased at a participating retail grocery store.

In one embodiment, each player (e.g., member of the sponsoring health insurance plan) can play once each calendar month. A new game board will be available at the beginning of each month. The earned savings for that month will be applied to all family members' cards.

Any adult member may initiate game play during the month, as long as the game has not yet started. The adult member can finish the game for the month, resetting the following month for any adult member to play. The game play is transferable between online and mobile applications, meaning if the player starts on the mobile application, they may continue online, and vice versa. After the game is played for the month, the remaining six unturned tiles are revealed to the player.

The game may be configured to cap the amount of saving allowed. For example, the maximum annual savings allowed may be set at $600 per health insurance policy. If a member hits the $600 annual cap, a message can be displayed to the member that they can replay beginning on January 1 of the following year; regardless of when policy date starts. Members have the ability to view game history, including the earned previous month's savings.

### Game Play Rules:

In one embodiment of the invention, the game rules include the following:
1. Each game board will have 12 tiles (e.g., squares); with six tiles hiding a healthy food and six tiles hiding a non-healthy food;
2. The player may randomly select a tile to reveal what is under it, repeating this process until six tiles are flipped over;
3. Healthy food picks increase the savings discount, non-healthy food picks do not;
4. The number of healthy food squares uncovered determines the earned savings for the month.

| Number of Healthy Items | Vitality HealthyFood | |
|---|---|---|
| Uncovered | Discount* | Probability |
| 0-2 | 5% | 28.4% |
| 3-4 | 10% | 67.6% |
| 5 | 25% | 3.9% |
| 6 | 50% | 0.1% |
| Weighted Average Discount | 9.2% | |

Other embodiments of the game system may include:
the ability to present a virtual card that may be used during the point of sale transaction at all participating retail stores nationwide. The virtual card will be supplemental to the current, physical shopping card.
the ability to call and activate a new or lost/stolen card, dialing directly into an interactive voice-recognition system.
the ability to provide a quick fact and/or advice regarding healthy or non-healthy food upon user selection of a game tile.
the ability to provide random game tiles that provides a free healthy food item for the month.
provide random healthy food tiles that provide a greater or additional discount on particular items (e.g., turn over a banana and earn a buy-one, get one free banana).
expand the list of eligible items to national manufacturer brands.

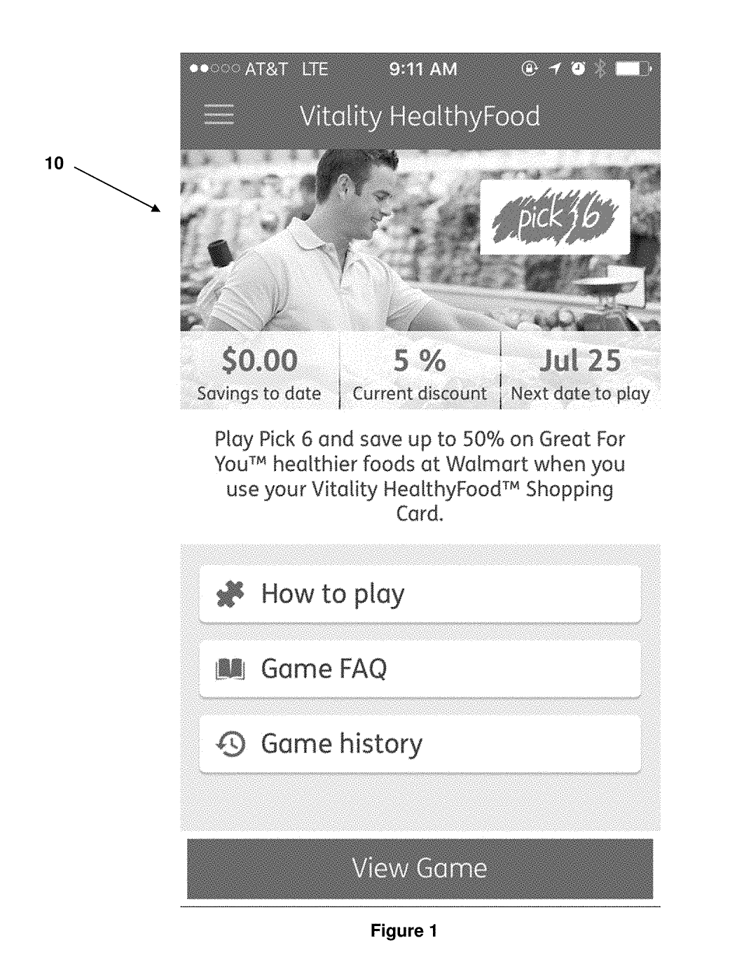

FIG. 1 illustrates one embodiment of the home screen for a mobile application game 10 for the present invention. The game may be implemented as a mobile processing application downloadable to a smart phone or tablet. As illustrated, the home screen displays the member's savings to date as well as the current discount earned for the current game interval.

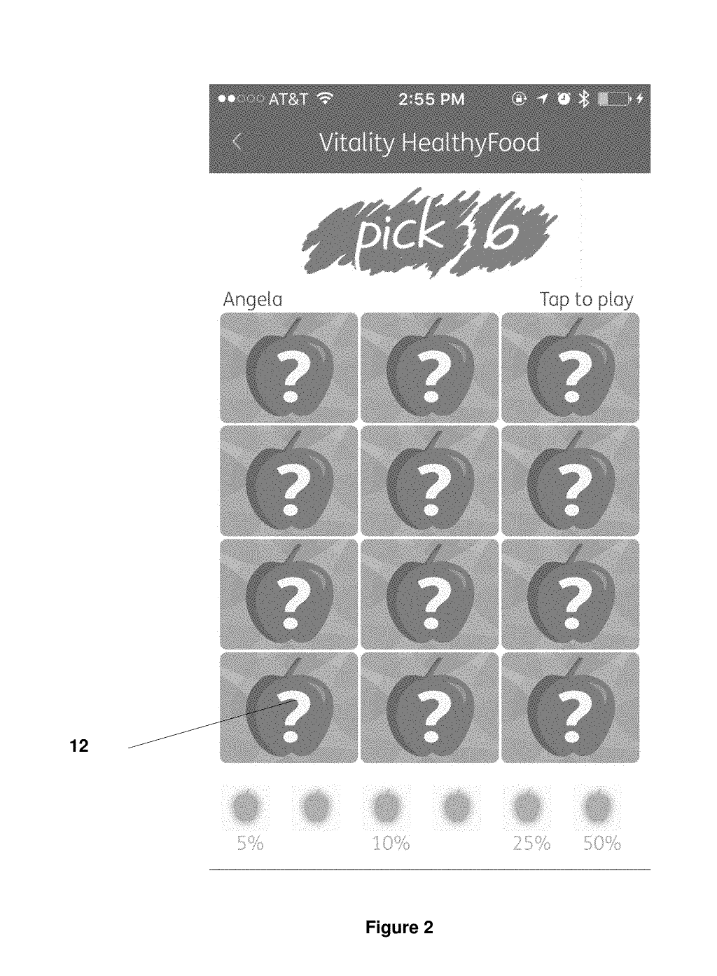

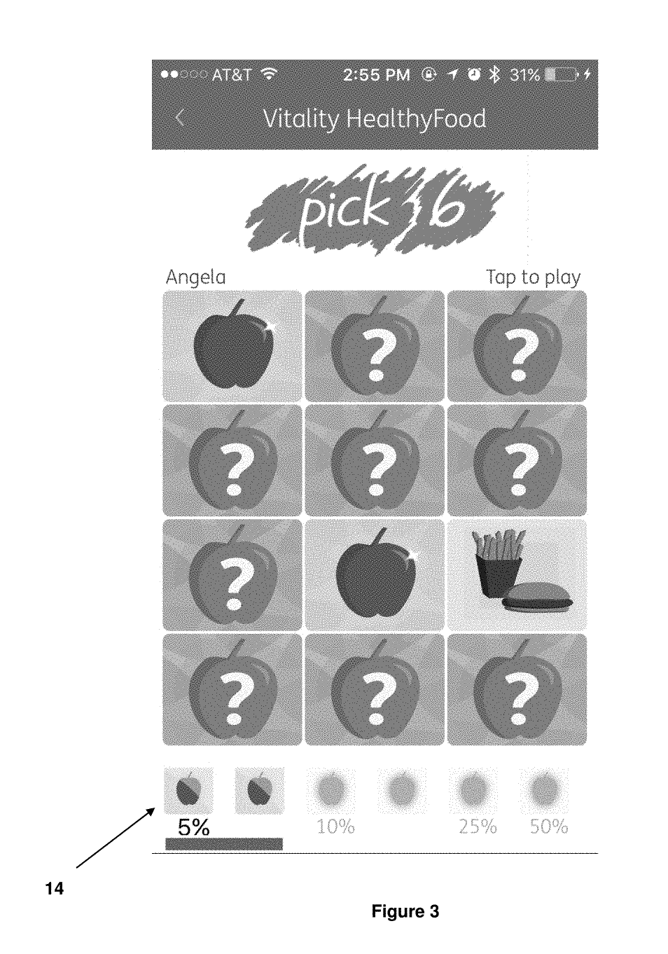

FIG. 2 illustrates one embodiment of an electronic game board of the present invention. In this embodiment, the game board has 12 tiles 12 that the user may click on to uncover the hidden food item. In this embodiment, the player may select up to six tiles. Six of the tiles hides a healthy food item (e.g., an apple), and six tiles hide an unhealthy food item (e.g., fast food hamburger). FIG. 3 illustrates the electronic game board of FIG. 2 showing three of the game objects selected by the player uncovering hidden food items. The game board display also has an area 14 for displaying the number of healthy food items uncovered or selected along with the corresponding savings discount earned.

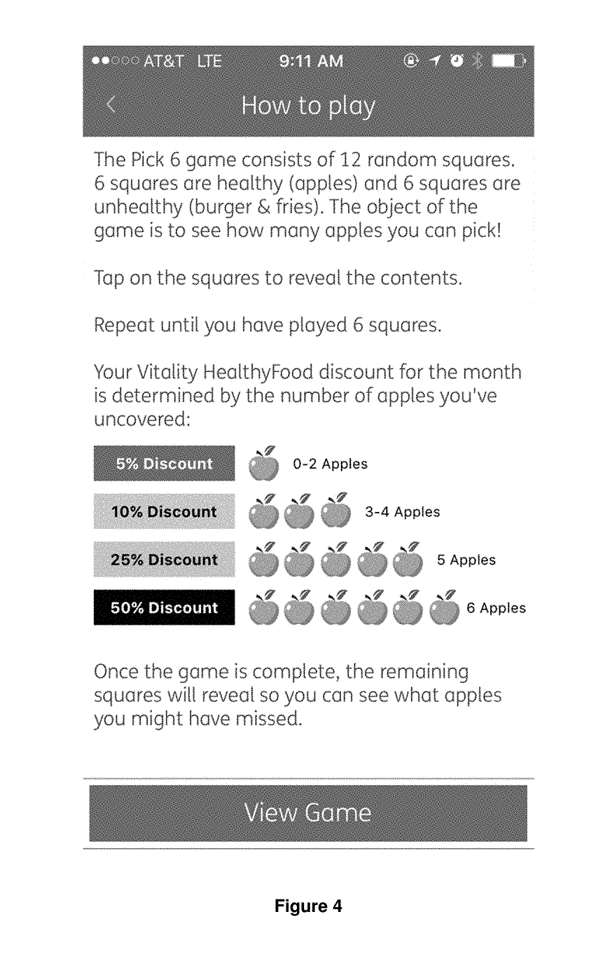

FIG. 4 illustrates one embodiment of the rules screen of the present invention.

Once the member completes the game, in one embodiment, the result (how many healthy tiles were flipped) is communicated via a real-time web API to the loyalty and rewards system. The loyalty and rewards processing system will process the game result, store it in their database, and determine the correct savings percentage for the member based on the game result. In one embodiment, the system will transmit (on a daily basis) the file data to the participating grocery—which means looking for any changes since the last run, and sending those in a batch file to the grocery. The participating grocery will process the file and store the records internally so that when a member scans the card, the discount is received real-time for that transaction.

In one embodiment, the information sent to the participating grocery includes:
Member's 16 digit HealthyFood card number;
An Add or Remove record indicator;
   (e.g. if month 1 user was at 10%, month 2 user earned 25%, we remove the 10% and add the 25% for month 2 savings percentage)
Program ID which maps to a percentage on the grocery's side;
   Currently the Program ID could be one of five 5 amounts—0%, 5%, 10%, 25%, 50%
Percentage discount.
   The file format is a pipe delimited .txt file.

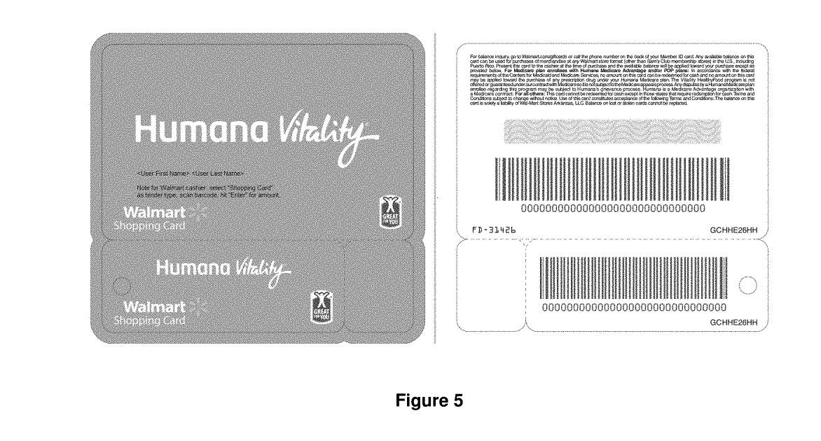

In one embodiment, the user redeems his discount by using a co-branded shopping card (co-branded by the participating health insurer and grocery store). FIG. 5 illustrates one embodiment of the user card for use at retail stores. The user receives both a standard-size wallet card and a key fob type card.

The user has two methods in which they can check out—at self-checkout or at the cashier.

### Self-Checkout:

1. Scan all of your items, then select “Finish & Pay.”
2. Select “Shopping Card” and scan your HealthyFood Shopping Card.
3. Select your final method of payment and pay for your items.
   or

### Cashier:

After the cashier tells you the amount you owe, scan the HealthyFood Shopping card to obtain the discount.

The participating grocery store may be given authority to determine and classify healthy food items that are eligible for discounts. The eligible items can be identified in-store or on packaging. It is preferred that they healthy food items meet rigorous nutrition criteria informed by the latest nutrition science and authoritative guidance from the 2010 Dietary Guidelines for Americans, U.S. Food and Drug Administration (FDA), U.S. Department of Agriculture (USDA) and Institute of Medicine (IOM).

While certain embodiments of the present invention are described in detail above, the scope of the invention is not to be considered limited by such disclosure, and modifications are possible without departing from the spirit of the invention as evidenced by the following claims. For example, other types of health items other than food may be hidden behind the game times. For example, a health food store can run discounts on vitamins, health supplements, or other health items using the game system of the present invention.

What is claimed is:

1. A game system for incentivizing people to eat healthy, comprising:
a mobile processing application;
an electronic game board generated by the mobile processing application, the electronic game board comprising a plurality of game objects, wherein some of the plurality of game objects are associated with a healthy food item and wherein some of the plurality of game objects are associated with an unhealthy food item;
a database for storing identification information for a player and current health food discount data for the player;
wherein said mobile processing application is programmed with one or more software routines executing on the mobile processing application to: 1) generate the electronic game board; 2) allow the player to select a predetermined number of game objects; 3) display either a healthy food item or an unhealthy food item each time the player selects a game object; 4) determine the player's current health food discount based on the number of game objects selected by the player associated with a healthy food item; 5) store the current health food discount data for the player after the player makes all of the predetermined number of selections.

2. The game system of claim 1, further comprising:
a barcode or token for identifying the player;
a remote processing system, wherein said remote processing system is programmed with one or more software routines executing on the remote processing system to: 1) receive player's identification information and the player's current health food discount; 2) store the player's current health food discount; 3) apply the player's health food discount by taking reducing the price of healthy foods purchased at a participating grocery store.

3. The game system of claim 1, wherein the mobile processing application is programmed with one or more software routines executing on the mobile processing application to: randomly associate each of the game objects with either a healthy food item or an unhealthy food item.

4. The game system of claim 1, wherein the mobile processing application is programmed with one or more software routines executing on the mobile processing application to: transmit the current health food discount to a remote processing system for storage.

5. The game system of claim 1, wherein the mobile processing application is programmed with one or more software routines executing on the mobile processing application to: display the player's health food discount after the player's selection of a game object.

6. A game system for incentivizing people to eat healthy, comprising:
a mobile processing application;
an electronic game board generated by the mobile processing application, the electronic game board comprising a plurality of game objects, wherein some of the plurality of game objects are associated with a healthy food item and wherein some of the plurality of game objects are associated with an unhealthy food item;
a database for storing identification information for a player and current health food discount data for the player;
wherein said mobile processing application is programmed with one or more software routines executing on the mobile processing application to: 1) generate the electronic game board; 2) allow the player to select a predetermined number of game objects; 3) display either a healthy food item or an unhealthy food item every time the player selects a game object; 4) determine the player's current health food discount based on the number of game objects selected by the player associated with a healthy food item; 5) storing the current health food discount data for the player after the player makes all of the predetermined number of selections;
a remote processing system, wherein said remote processing system is programmed with one or more software routines executing on the remote processing system to: 1) receive player's identification information and the player's current health food discount; 2) store the player's current health food discount; 3) apply the player's health food discount by reducing the price of healthy foods purchased at a participating grocery store.

7. The game system of claim 6, wherein the mobile processing application is programmed with one or more software routines executing on the mobile processing application to: randomly associate each of the game objects with either a healthy food item or an unhealthy food item.

8. The game system of claim 6, wherein the mobile processing application is programmed with one or more software routines executing on the mobile processing application to: transmit the current health food discount to the remote processing system for storage.

9. The game system of claim 6, wherein the mobile processing application is programmed with one or more software routines executing on the mobile processing application to: display the player's health food discount after the player's selection of a game object.

10. The game system of claim 6, wherein the mobile processing application is programmed with one or more software routines executing on the mobile processing application to: provide a quick fact regarding a healthy or non-healthy food item upon user selection of a game tile.

11. The game system of claim 6, wherein the mobile processing application is programmed with one or more software routines executing on the mobile processing application to: provide health advice regarding a healthy or non-healthy food item upon player selection of a game tile.

12. The game system of claim 6, wherein the mobile processing application is programmed with one or more software routines executing on the mobile processing application to: provide random game tiles that provides a free item for the month upon selection by a player.

13. The game system of claim 6, wherein the mobile processing application is programmed with one or more software routines executing on the mobile processing application to: display the number of healthy food items selected by the player.

14. The game system of claim 6, further comprising:
a packaging label indicating eligibility for the healthy food discount for placement onto healthy foods.

15. A game system for incentivizing people to eat healthy, comprising:
a mobile processing application;
an electronic game board generated by the mobile processing application, the electronic game board comprising a plurality of game objects, wherein some of the plurality of game objects are associated with a healthy food item and wherein some of the plurality of game objects are associated with an unhealthy food item;
a database for storing identification information for a player and current health food discount data for the player;
wherein said mobile processing application is programmed with one or more software routines executing on the mobile processing application to: 1) generate the electronic game board; 2) allow the player to select a predetermined number of game objects; 3) displaying either a healthy food item or an unhealthy food item every time the player selects a game object; 4) determine the player's current health food discount based on the number of game objects selected by the player associated with a healthy food item; 5) store the current health food discount data for the player after the player makes all of the predetermined number of selections; 6) randomly associate each of the game objects with either a healthy food item or an unhealthy food item; 6) display the player's health food discount after the player's selection of a game object;
a remote processing system, wherein said remote processing system is programmed with one or more software routines executing on the remote processing system to: 1) receive player's identification information and the player's current health food discount; 2) store the player's current health food discount; 3) apply the player's health food discount by reducing the price of healthy foods purchased at a participating grocery store.

16. The game system of claim 15, wherein the mobile processing application is programmed with one or more software routines executing on the mobile processing application to: provide a quick fact regarding a healthy or non-healthy food item upon user selection of a game tile.

17. The game system of claim 15, wherein the mobile processing application is programmed with one or more software routines executing on the mobile processing application to: provide health advice regarding a healthy or non-healthy food item upon player selection of a game tile.

18. The game system of claim 15, wherein the mobile processing application is programmed with one or more software routines executing on the mobile processing application to: provide random game tiles that provides a free healthy food item for the month upon selection by a player.

19. The game system of claim 15, wherein the mobile processing application is programmed with one or more software routines executing on the mobile processing application to: display the number of healthy food items selected by the player.

20. The game system of claim 15, further comprising:
a packaging label indicating eligibility for the healthy food discount for placement onto healthy foods.

21. The game system of claim 15, wherein the mobile processing application is programmed with one or more software routines executing on the mobile processing application to: provide the player's savings to date.

22. The game system of claim 15, wherein the mobile processing application is programmed with one or more software routines executing on the mobile processing application to: randomly provide game tiles that provide a greater discount on particular healthy food items upon selection by the player.

23. The game system of claim 15, wherein the mobile processing application is programmed with one or more software routines executing on the mobile processing application to: randomly provide game tiles that provide an additional discount on particular healthy food items upon selection by the player.

24. A game system for incentivizing people to maintain a healthy lifestyle, comprising:
a mobile processing application;
an electronic game board generated by the mobile processing application, the electronic game board comprising a plurality of game objects, wherein some of the plurality of game objects are associated with a healthy item and wherein some of the plurality of game objects are associated with an unhealthy item;
a database for storing identification information for a player and current health discount data for the player;
wherein said mobile processing application is programmed with one or more software routines executing on the mobile processing application to: 1) generate the electronic game board; 2) allow the player to select a predetermined number of game objects; 3) display either a healthy item or an unhealthy item each time the player selects a game object; 4) determine the player's current health discount based on the number of game objects selected by the player associated with a healthy item; 5) store the current health discount data for the player after the player makes all of the predetermined number of selections.

25. The game system of claim 24, further comprising:
a barcode or token for identifying the player;
a remote processing system, wherein said remote processing system is programmed with one or more software routines executing on the remote processing system to: 1) receive player's identification information and the player's current health discount; 2) store the player's current health discount; 3) apply the player's health discount by taking reducing the price of healthy items purchased at a participating retail store.

26. The game system of claim 24, wherein the mobile processing application is programmed with one or more software routines executing on the mobile processing application to: randomly associate each of the game objects with either a healthy item or an unhealthy item.

27. The game system of claim 24, wherein the mobile processing application is programmed with one or more software routines executing on the mobile processing application to: transmit the current health discount to a remote processing system for storage.

28. The game system of claim 24, wherein the mobile processing application is programmed with one or more software routines executing on the mobile processing application to: randomly provide game tiles that provide a greater discount on particular healthy items upon selection by the player.

29. The game system of claim 24, wherein the mobile processing application is programmed with one or more software routines executing on the mobile processing application to: randomly provide game tiles that provide an additional discount on particular healthy items upon selection by the player.
